(19) United States
(12) Patent Application Publication
(10) Pub. No.: US 2005/0134677 A1
(43) Pub. Date: Jun. 23, 2005

(54) Image-forming apparatus

(76) Inventors: Shinpei Kawasaki, Tokyo (JP); Tadashi Matsudaira, Tokyo (JP); Hiroshi Oyama, Tokyo (JP); Katsunori Takahashi, Tokyo (JP); Masayuki Watanabe, Tokyo (JP)

Correspondence Address: CANTOR COLBURN LLP, 55 Griffin Road South, Bloomfield, CT, 06002, US

(21) Appl. No.: 10/926,869

(22) Filed: Aug. 26, 2004

(30) Foreign Application Priority Data
Dec. 4, 2003 (JP) JP2003-405363

(51) Int. Cl. B41J 2/435

(52) U.S. Cl. 347/238

(57) ABSTRACT

There is described an image-forming apparatus, which make it possible to prevent the occurrence of the image unevenness without complicating the configuration of the image-forming apparatus and without increasing the cost of the image-forming apparatus. The image-forming apparatus includes an image-bearing member; an image writing device, having a LED array head in which a plurality of LED elements are arranged in a line, to form a electrostatic latent image on the image-bearing member; a calculating section to calculate compensation values utilized for correcting light intensities of the LED elements included in the LED array head, based on distance information between the image-bearing member and the LED array head; a correction controlling section to correct the light intensities of the LED elements included in the LED array head, based on the compensation values; and a storage device to store the distance information between the image-bearing member and the LED array head.

### BACKGROUND OF THE INVENTION

The present invention relates to an image-forming apparatus capable of preventing image unevenness in a sub-scanning direction.

As image writing devices employed for the image-forming apparatus, there have been well-known a laser-beam scanning type device that is provided with a laser light source and a rotating multi-surface mirror, such as a polygon mirror, and a linear-array light-source-type device that is provided with a LED-array head in which a plurality of LED elements are arrayed in a line. Since the image-writing device of the linear-array light-source type can be disposed near an image-bearing member, it has been contributed to a minimization of the whole scale of the image-forming apparatus.

When the LED-array head is employed as the image-writing device of the linear-array light-source type, correcting operations are applied to the LED-array head so as to uniform light intensities and dot diameters among the LED elements included in the LED-array head. On the other hand, since the image-bearing member is rotated by a driving device, a deviation from its circular form and/or mechanical vibrations of the rotating image-bearing member cause a surface vibration phenomenon in which the surface of the image-bearing member oscillates up and down. Such the surface vibration could be a cause of image abnormalities, such as the image unevenness, etc., since the distance between the LED-array head and the surface of the image-bearing member cannot be maintained at a constant value within one revolution of the image-bearing member, thereby the light intensities and dot diameters of the LED-light irradiated onto the surface of the image-bearing member cannot be kept constant.

To prevent the abovementioned image abnormalities, there has been proposed an image-writing device that is provided with a storage device for storing information, which represent rotation angles of the image-bearing member and distances to the LED-array head, and a driving circuit for driving the LED-array head, so as to drive the LED-array head corresponding to the rotation angles of the image-bearing member (e.g. refer to Patent Document 1). According to the image-writing device mentioned above, it becomes possible to keep the distance between the LED-array head and the surface of the image-bearing member constant.

[Patent Document 1]

Tokkaihei 6-198956

In the image-writing device set forth in Patent Document 1, however, since the distance between the LED-array head and the surface of the image-bearing member is kept constant by controlling the driving circuit for driving the LED-array head, a mechanically-complicated configuration should be introduced in the image-writing device. Accordingly, such the complicated configuration makes it difficult to improve the controlling accuracy and would result in an insufficient trackability when the recording velocity is high.

### SUMMARY OF THE INVENTION

To overcome the abovementioned drawbacks in conventional image-forming apparatus, it is an object of the present invention to provide image-forming apparatus, which make it possible to prevent the occurrence of the image unevenness without complicating the configuration of the image-forming apparatus and without increasing the cost of the image-forming apparatus.

Accordingly, to overcome the cited shortcomings, the abovementioned object of the present invention can be attained by image-forming apparatus described as follow.

(1) An apparatus for forming an image, comprising: an image-bearing member; an image writing device, having a LED array head in which a plurality of LED elements are arranged in a line, to form a electrostatic latent image on the image-bearing member; a calculating section to calculate compensation values utilized for correcting light intensities of the LED elements included in the LED array head, based on distance information between the image-bearing member and the LED array head; and a correction controlling section to correct the light intensities of the LED elements included in the LED array head, based on the compensation values.

(2) The apparatus of item 1, further comprising: a storage device to store the distance information between the image-bearing member and the LED array head.

(3) The apparatus of item 1, further comprising: a detecting device to detect the distance information between the image-bearing member and the LED array head.

(4) The apparatus of item 1, further comprising: a reference position detecting device to detect a reference position mark that is formed on the image-bearing member; wherein the correction controlling section corrects the light intensities of the LED elements included in the LED array head, based on the compensation values and information of the reference position mark detected by the reference position detecting device.

(5) The apparatus of item 1, wherein the calculating section has a compensation-value table indicating the compensation values corresponding to distances between the image-bearing member and the LED array head.

(6) An apparatus for forming an image on a transfer sheet, comprising: an image-bearing member; an image writing device, having a LED array head in which a plurality of LED elements are arranged in a line, to form a electrostatic latent image on the image-bearing member; a developing device to develop the electrostatic latent image with toner, so as to form a toner image on the image-bearing member; a transferring device to transfer the toner image formed on the image-bearing member onto the transfer sheet; a detecting device to detect a surface vibration of the image-bearing member; a calculating section to calculate compensation values from values detected by the detecting device; and a correction controlling section to correct the light intensities of the LED elements included in the LED array head, based on the compensation values calculated by the calculating section.

(7) The apparatus of item 6, further comprising: a reference position detecting device to detect a reference position mark that is formed on the image-bearing member; wherein the calculating section creates a compensation-value table, based on values detected by the detecting device during one revolution of the image-bearing member from a time when the reference position detecting device detects the reference position mark; and wherein the correction controlling section corrects the light intensities of the LED elements included in the LED array head, based on the compensation values indicated in the compensation-value table.

(8) The apparatus of item 6, wherein the correction controlling section conducts a correcting operation for every predetermined line.

(9) The apparatus of item 6, further comprising: an operating section; wherein a timing for conducting a correcting operation is established by inputting setting items from the operating section.

(10) An apparatus for forming an image on a transfer sheet, comprising: an image-bearing member; an image writing device, having a LED array head in which a plurality of LED elements are arranged in a line, to form a electrostatic latent image on the image-bearing member; a developing device to develop the electrostatic latent image with toner, so as to form a toner image on the image-bearing member; a transferring device to transfer the toner image formed on the image-bearing member onto the transfer sheet; a plurality of detecting devices to detect a surface vibration of the image-bearing member; a calculating section to calculate compensation values from values detected by the plurality of detecting devices; and a correction controlling section to correct the light intensities of the LED elements included in the LED array head, based on the compensation values calculated by the calculating section.

(11) The apparatus of item 10, wherein the plurality of detecting devices are arranged in a main-scanning direction.

(12) The apparatus of item 11, wherein the plurality of detecting devices are respectively disposed at positions near both ends of the image-bearing member.

(13) The apparatus of item 11, wherein the calculating section finds the compensation values for the LED array head in the main-scanning direction, based on detected results of the plurality of detecting devices.

(14) The apparatus of item 9, further comprising: a reference position detecting device to detect a reference position mark that is formed on the image-bearing member; wherein the calculating section creates a compensation-value table, based on values detected by the detecting device during one revolution of the image-bearing member from a time when the reference position detecting device detects the reference position mark; and wherein the correction controlling section corrects the light intensities of the LED elements included in the LED array head, based on the compensation values indicated in the compensation-value table.

(15) A method for forming an image by conducting a writing operation for an image-bearing member with a LED array head in which a plurality of LED elements are arranged in a line, comprising the steps of: acquiring information of surface vibrations of the image-bearing member; and correcting light intensities of the LED elements included in the LED array head, based on the information of surface vibrations.

### BRIEF DESCRIPTION OF THE DRAWINGS

Other objects and advantages of the present invention will become apparent upon reading the following detailed description and upon reference to the drawings in which:

FIG. 1 shows a schematic diagram of image-forming apparatus embodied in the present invention;

FIG. 2 shows a block diagram of a configuration embodied in the present invention;

FIG. 3 shows a block diagram of the second embodiment of the present invention;

FIG. 4 shows a layout of a compensation-value table;

FIG. 5 shows a block diagram of the third embodiment of the present invention; and

FIG. 6 shows a block diagram of the fourth embodiment of the present invention.

### DETAILED DESCRIPTION OF THE PREFERRED EMBODIMENT

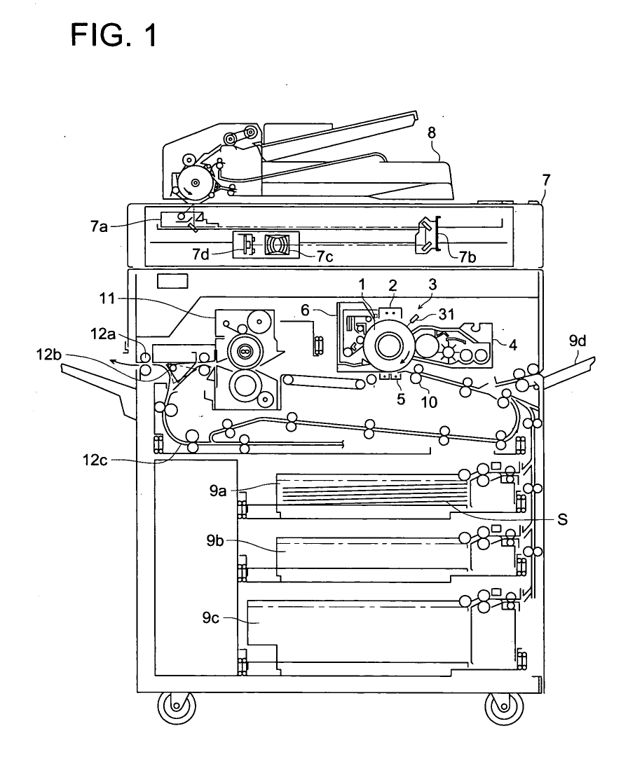

Next, referring to the drawings, the image-forming apparatus embodied in the present invention will be detailed in the following. FIG. 1 shows a configuration of the image-forming apparatus embodied in the present invention. In the image-forming apparatus embodied in the present invention, charging device 2, image-writing device 3, developing device 4, transferring device 5 and cleaning device 6 are disposed around image-bearing member 1, being a rotating drum-type member. Further, document reader 7 and automatic document feeder 8 are disposed on the upper side of the image-forming apparatus. Document sheets put on automatic document feeder 8 are conveyed one by one to document reader 7. In the document reader 7, light emitted from a light source mounted on first mirror unit 7a is irradiated onto the document sheet conveyed by automatic document feeder 8, so that the reflected light is focused onto CCD 7d through first mirror unit 7a, second mirror unit 7b and lens unit 7c. CCD 7d converts the focused image to electronic signals to store the electronic signals in a storage device (not shown in the drawings) equipped in the image-forming apparatus.

When images stored in the storage device reach to a predetermined amount, charging device 2 applies a uniform charging operation onto the surface of image-bearing member 1. Then, image-writing device 3 conducts an exposure scanning operation based on the image signals stored in the storage device to form an electrostatic latent image, and further, developing device 4 develops the electrostatic latent image with toner to form a toner image on the surface of image-bearing member 1.

On the other hand, transfer sheet TS is fed from paper feeding cassette 9a, 9b disposed at a sublevel of the image-forming apparatus, paper feeding mass-cassette 9c disposed at the lower level, manual paper-feeding cassette 9d disposed at the side surface, etc., and is conveyed to a transferring position through resist roller 10. Transferring device 5 transfers the toner image formed on the surface of image-bearing member 1 to transfer sheet TS at the transferring position. Successively, fixing unit 11 applies heat and pressure onto transfer sheet TS to fix the toner image on it. Then, paper ejecting roller 12a ejects transfer sheet TS.

When forming images on both sides of the transfer sheet TS, the conveying-path of transfer sheet TS branches off the normal ejecting path to inversion-conveying path 12c by means of conveying-path switching plate 12 after the fixing operation with heat and pressure is applied to one side of the transfer sheet TS in fixing unit 11, so as to inverse the surface of the transfer sheet TS by performing switchback action in the inversion-conveying path 12c. Then, the transfer sheet TS again passes through transferring device 5 to form a toner image on reverse side of the transfer sheet-TS, and then, is ejected to outside of the apparatus by means of paper ejecting roller 12a after the fixing operation with heat and pressure is applied to the reverse side of the transfer sheet TS in fixing unit 11. On the other hand, the surface of image-bearing member 1 after the image-forming operation is prepared for the next image-forming operation by removing residual developer remaining on the surface of the image-bearing member 1.

Image-writing device 3 is provided with LED-array head 31 including a LED array, in which a plurality of LED elements are arranged in a line, and a lens array, in which a plurality of lenses are arranged in a line. Since each of the LED elements included in the LED array corresponds to each of the lenses included in the lens array one by one, it is possible to form the electrostatic latent image on the surface of the image-bearing member 1 by focusing the lights emitted from the LED elements onto the surface through the lenses. Further, a driving electronic current and/or a light emitting duration of each of the LED elements are/is compensated for in advance, so that an equality of the light intensity between the LED elements can be kept.

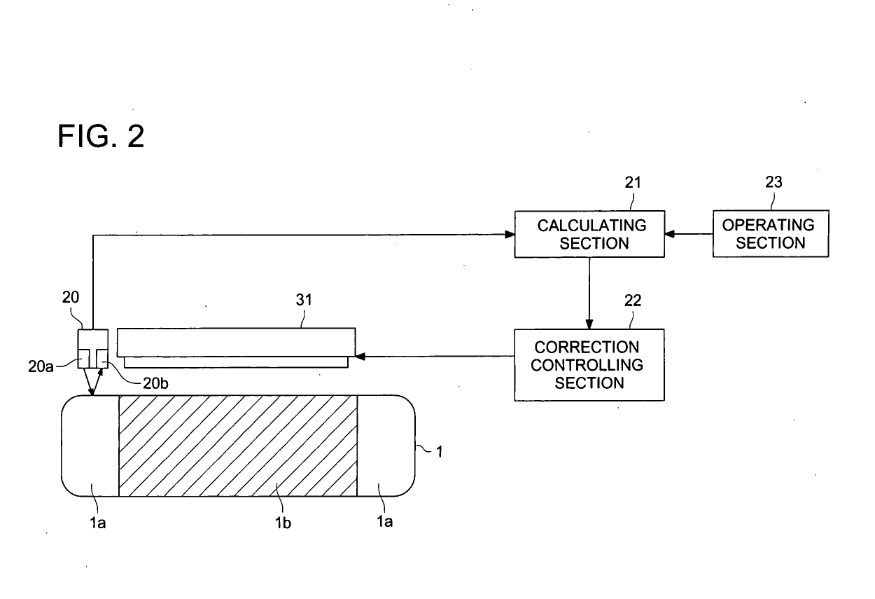

FIG. 2 shows a block diagram of an apparatus embodied in the present invention. In the cylindrical-type surface of image-bearing member 1, the both edge areas are non image-forming areas 1a that do not contribute the image-forming operation, and the other area, namely a hatched area indicated in FIG. 2, is image-forming area 1b. LED-array head 31 is disposed at an upper space of image-forming area 1b. The width of LED-array head 31 is equal to or slightly shorter than the width of image-forming area 1b. Further, detecting device 20 is disposed at an upper space of one of non image-forming areas 1a. Detecting device 20 includes light-emitting element 20a and light-receiving element 20b, so that light-emitting element 20a emits a light onto non image-forming area 1a of image-bearing member 1 and light-receiving element 20b receives a light reflected from the non image-forming area 1a. A value detected by light-receiving element 20b varies with the light amount reflected from non image-forming area 1a, and thereby, a distance between the surface of image-bearing member 1 and detecting device 20 can be calculated. The variation of the distance indicates a degree of surface vibration of image-bearing member 1.

Calculating section 21 calculates the degree of surface vibration of image-bearing member 1 on the basis of the value detected by detecting device 20, and thereby, calculates compensation values for correcting the light intensities of LED-array head 31. The compensation values could be represented by driving electronic currents and/or light emitting durations of the LED elements. Correction controlling section 22 corrects the light intensities of LED-array head 31 by employing the compensation values calculated by calculating section 21.

Sometimes, depending on a kind of image, a certain amount of image distortion with respect to the electrostatic latent image formed on the image-bearing member would be allowed. For instance, a document mainly including characters and sentences would be a good example for such the case. In such the case, it is applicable that the compensation timing be changed so that calculating section 21 calculates the compensation values at every constant interval, such as every two lines, three lines, etc.

Operating section 23, which includes a hard-key section for inputting a number of sheets on which images are to be formed, etc., and a displaying section for displaying setting contents, is disposed at an upper side of the image-forming apparatus. A touch panel is equipped on the displaying section to input setting items, such as an image-forming mode, etc. The aforementioned compensation timing can be inputted from the hard-key section of operating section 23 as a numeral value or by selecting a value from a menu displayed on the displaying section. The values inputted by the operator are sent to calculating section 21, so that the calculating section 21 can calculate compensation values according to the received values.

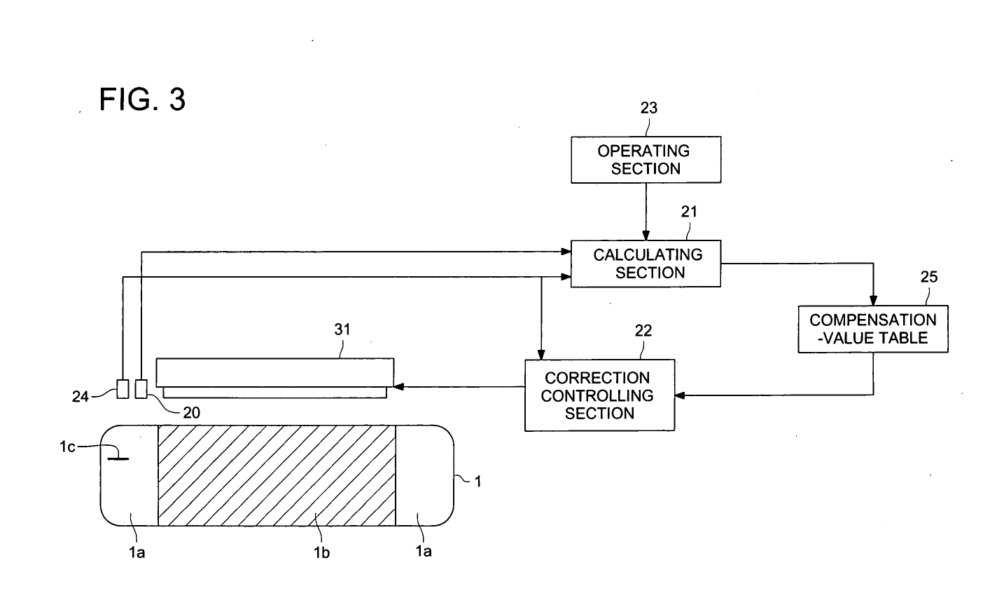

FIG. 3 shows a block diagram of another apparatus embodied in the present invention. In the aforementioned embodiment shown in FIG. 2, calculating section 21 calculates the compensation values by employing the values detected by detecting device 20, and then, correction controlling section 22 conducts the correcting operation of LED-array head 31. Therefore, the embodiment shown in FIG. 2 is suitable for correcting errors caused by irregular vibrations. On the other hand, when a deformation of image-bearing member 1 from a circular form is causing periodical errors, calculating section 21 shown in FIG. 2 would repeat the same calculations many times. In order to save a loss time due to such the repeat of the same calculations, the embodiment shown in FIG. 3 calculates the compensation values in advance when the image-forming operation is not performed, and at the time of the image-forming operation, the light intensities of LED-array head 31 are corrected by employing the compensation values calculated in advance.

Reference position mark 1c, that indicates a calculation timing of the compensation value and a start point of the correction controlling operation at the time of the image-forming operation, is equipped at an end of image-bearing member 1. Although a straight black line represents the reference position mark 1c in FIG. 3, the reference position mark is not limited to such the straight black line, but there would be many other symbols applicable for this purpose.

Reference position detecting device 24 for detecting the reference position mark 1c is disposed at a position near a side of detecting device 20. The compensation values calculated by calculating section 21 are stored in a compensation-value table 25 whose memory area is reserved in a storage device (not shown in the drawings).

In a same manner as in the embodiment shown in FIG. 2, the compensation timing can be inputted from operating section 23. As shown in FIG. 3, by sending the setting information to calculating section 21, calculating section 21 calculates the compensation values at constant intervals. It is also applicable, however, that, by sending the setting information to correction controlling section 22, the correction controlling section 22 acquires the compensation values from the compensation-value table 25.

During a time interval when the image-forming operation is not performed, such as the time just after a power source of the image-forming apparatus is turned ON, etc., calculating section 21 calculates the compensation values. Further, the image-bearing member 1 is also rotated during the time interval when the image-forming operation is not performed. Calculating section 21 conducts the detecting operation by means of detecting device 20 after reference position detecting device 24 detects the reference position mark 1c. Then, the compensation values calculated by calculating section 21 are stored in the compensation-value table 25. The detecting operation by means of detecting device 20, the calculating operation by means of calculating section 21 and the storing operation for the compensation-value table 25 are conducted during one revolution of the reference position mark 1c, namely, until the reference position mark 1c is again detected by reference position detecting device 24.

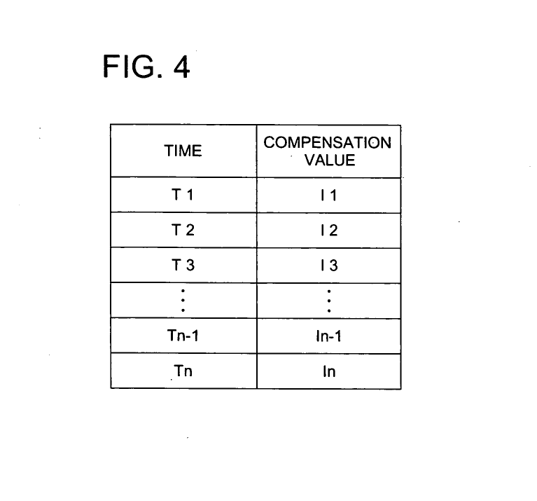

FIG. 4 shows a layout of the compensation-value table. The compensation-value table 25 is constituted by two columns, namely, the first column indicates elapsed times from the time when reference position detecting device 24 detects the reference position mark 1c and the second column indicates the compensation values corresponding to the elapsed times. Accordingly, the compensation values during the one revolution of image-bearing member 1 are stored in the compensation-value table 25.

Incidentally, although FIG. 4 shows an exemplified table in which the compensation values are stored in the compensation-value table 25 corresponding to the elapsed times from the time of detecting the reference position mark 1c, it is also applicable that, instead of employing the elapsed times, the first line is set at the reference position mark 1c and the compensation value is stored for every line.

Now, returning to FIG. 3, the procedure for conducting the image-processing operation will be described as follow. At first, correction-controlling section 22 readouts the compensation values stored in the compensation-value table 25, referring to the time when reference position detecting device 24 detects the reference position mark 1c on the image-bearing member 1. Then, the correction-controlling section 22 corrects the light intensities of LED-array head 31 by employing the compensation values readout in the above.

Next, referring to the third embodiment, the present invention will be further detailed in the following.

In the third embodiment, the distance information between LED-array head 31 and image-bearing member 1, which corresponds to the surface vibration, are provided in advance as an information table, so that the compensation values can be calculated by employing the information table at the time of the image-recording operation, and thereby the correcting operation is conducted.

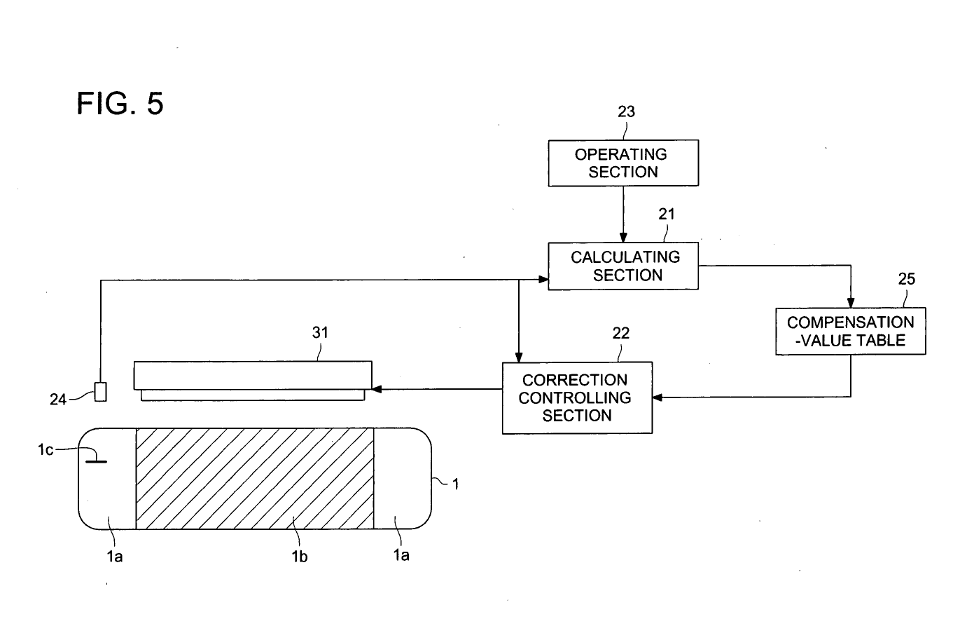

Referring to FIG. 5, the third embodiment, which is derived by partially modifying the second embodiment shown in FIG. 3, will be detailed in the following. The different point between the second and the third embodiment is that, instead of equipping the detecting device, the compensation-value table, to be employed for the correcting operation, is prepared in advance as a default information table established in the factory. In this configuration, the operation for correcting the light intensities of LED-array head 31 is conducted in the same manner as that in the second embodiment at the time of the image-forming operation. The compensation-value table employed in the third embodiment is the same as that employed in the second embodiment as shown in FIG. 4, and the correcting operation is conducted by detecting the reference position mark 1c. Incidentally, although the compensation values based on the distance information are described in the compensation-value table shown in FIG. 4, it is also applicable that the distances between LED-array head 31 and image-bearing member 1 are described in the compensation-value table. Calculating section 21 finds the compensation values for correcting the light intensities of LED-array head 31 from the distance information mentioned above, so that the correction-controlling section 22 can conduct the correcting operation.

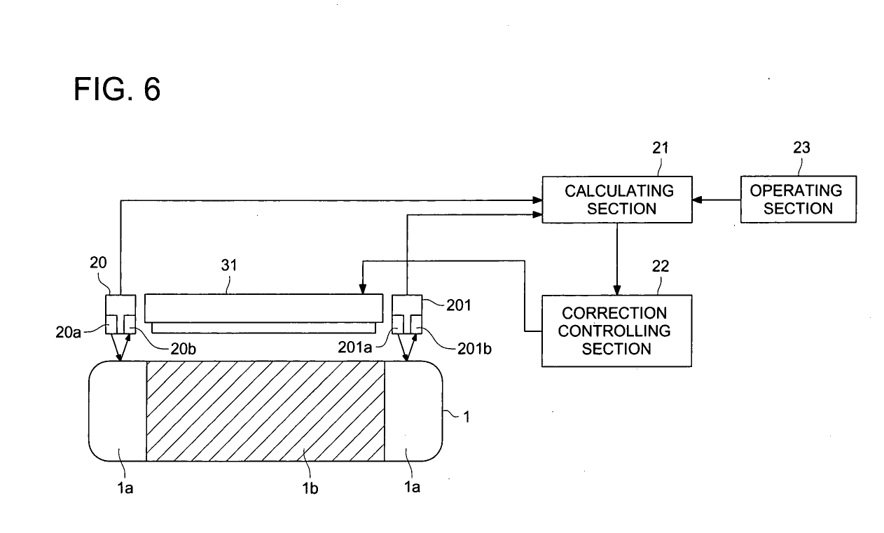

Successively, the fourth embodiment will be described as follow. In the fourth embodiment, plural detecting devices equipped in a main-scanning direction make it possible to correct the surface vibrations in the main-scanning direction. Referring to FIG. 6, the fourth embodiment will be detailed in the following. In the fourth embodiment, two detecting devices, namely, first detecting device 20 and second detecting device 201 are equipped in a main-scanning direction. It is desirable that such the two detecting devices are respectively disposed near the both ends of image-bearing member 1. According to the configuration mentioned above, it becomes possible to detect and correct the surface vibrations occurring in the main-scanning direction, as well as those in the sub-scanning direction (rotating direction of the image-bearing member). Basically, with respect to the detecting and correcting operations for the surface vibrations, it is possible to employ the same methods as those employed in the first and second embodiment. Incidentally, with respect to the surface vibration at each position of the image-bearing member 1, it is possible to calculate from the values of the two detecting devices by employing the linear approximation method, etc. Calculating section 21 employs the above-calculated result to calculate the compensation value for correcting the light intensity of each of the LED elements arrayed in the main-scanning direction of LED-array head 31, and then, the correction-controlling section conducts a correcting operation. Further, calculating section 21 finds the compensation values for the LED-array head in the main-scanning direction from the detected results of the plural detecting devices mentioned above.

Incidentally, although the monochrome image-forming apparatus is exemplified in the abovementioned embodiments, the scope of the present invention is not limited to the monochrome image-forming apparatus. It is needless to say that the present invention can be also applied to a color image-forming apparatus.

Disclosed embodiment can be varied by a skilled person without departing from the spirit and scope of the invention.

1. An apparatus for forming an image, comprising:
an image-bearing member;
an image writing device, having a LED array head in which a plurality of LED elements are arranged in a line, to form a electrostatic latent image on said image-bearing member;
a calculating section to calculate compensation values utilized for correcting light intensities of said LED elements included in said LED array head, based on distance information between said image-bearing member and said LED array head; and
a correction controlling section to correct said light intensities of said LED elements included in said LED array head, based on said compensation values.

2. The apparatus of claim 1, further comprising:
a storage device to store said distance information between said image-bearing member and said LED array head.

3. The apparatus of claim 1, further comprising:
a detecting device to detect said distance information between said image-bearing member and said LED array head.

4. The apparatus of claim 1, further comprising:
a reference position detecting device to detect a reference position mark that is formed on said image-bearing member;
wherein said correction controlling section corrects said light intensities of said LED elements included in said LED array head, based on said compensation values and information of said reference position mark detected by said reference position detecting device.

5. The apparatus of claim 1,
wherein said calculating section has a compensation-value table indicating said compensation values corresponding to distances between said image-bearing member and said LED array head.

6. An apparatus for forming an image on a transfer sheet, comprising:
an image-bearing member;
an image writing device, having a LED array head in which a plurality of LED elements are arranged in a line, to form a electrostatic latent image on said image-bearing member;
a developing device to develop said electrostatic latent image with toner, so as to form a toner image on said image-bearing member;
a transferring device to transfer said toner image formed on said image-bearing member onto said transfer sheet;
a detecting device to detect a surface vibration of said image-bearing member;
a calculating section to calculate compensation values from values detected by said detecting device; and
a correction controlling section to correct said light intensities of said LED elements included in said LED array head, based on said compensation values calculated by said calculating section.

7. The apparatus of claim 6, further comprising:
a reference position detecting device to detect a reference position mark that is formed on said image-bearing member;
wherein said calculating section creates a compensation-value table, based on values detected by said detecting device during one revolution of said image-bearing member from a time when said reference position detecting device detects said reference position mark; and
wherein said correction controlling section corrects said light intensities of said LED elements included in said LED array head, based on said compensation values indicated in said compensation-value table.

8. The apparatus of claim 6,
wherein said correction controlling section conducts a correcting operation for every predetermined line.

9. The apparatus of claim 6, further comprising:
an operating section;
wherein a timing for conducting a correcting operation is established by inputting setting items from said operating section.

10. An apparatus for forming an image on a transfer sheet, comprising:
an image-bearing member;
an image writing device, having a LED array head in which a plurality of LED elements are arranged in a line, to form a electrostatic latent image on said image-bearing member;
a developing device to develop said electrostatic latent image with toner, so as to form a toner image on said image-bearing member;
a transferring device to transfer said toner image formed on said image-bearing member onto said transfer sheet;
a plurality of detecting devices to detect a surface vibration of said image-bearing member;
a calculating section to calculate compensation values from values detected by said plurality of detecting devices; and
a correction controlling section to correct said light intensities of said LED elements included in said LED array head, based on said compensation values calculated by said calculating section.

11. The apparatus of claim 10,
wherein said plurality of detecting devices are arranged in a main-scanning direction.

12. The apparatus of claim 11,
wherein said plurality of detecting devices are respectively disposed at positions near both ends of said image-bearing member.

13. The apparatus of claim 11,
wherein said calculating section finds said compensation values for said LED array head in said main-scanning direction, based on detected results of said plurality of detecting devices.

14. The apparatus of claim 9, further comprising:
a reference position detecting device to detect a reference position mark that is formed on said image-bearing member;
wherein said calculating section creates a compensation-value table, based on values detected by said detecting device during one revolution of said image-bearing member from a time when said reference position detecting device detects said reference position mark; and
wherein said correction controlling section corrects said light intensities of said LED elements included in said LED array head, based on said compensation values indicated in said compensation-value table.

15. A method for forming an image by conducting a writing operation for an image-bearing member with a LED array head in which a plurality of LED elements are arranged in a line, comprising the steps of:
acquiring information of surface vibrations of said image-bearing member; and
correcting light intensities of said LED elements included in said LED array head, based on said information of surface vibrations.
